(19) United States
(12) Patent Application Publication
(10) Pub. No.: US 2014/0018590 A1
(43) Pub. Date: Jan. 16, 2014

(54) PERFORMANCE OF A HYDROCARBON CONVERSION OR PROCESSING OF A HYDROCARBON CONVERSION IN APPARATUSES WITH SURFACES MADE FROM NONMETALLIC MATERIALS

(71) Applicant: BASF SE, Ludwigshafen (DE)

(72) Inventors: Steffen Tschirschwitz, Mannheim (DE); Joni Joni, Sulzbach (DE); Daniel Pfeiffer, Neustadt (DE); Stefan Bitterlich, Dirmstein (DE); Michael Hübner, Lampertheim (DE)

(21) Appl. No.: 13/937,402

(22) Filed: Jul. 9, 2013

Related U.S. Application Data
(60) Provisional application No. 61/670,133, filed on Jul. 11, 2012.

(51) Int. Cl. B01J 19/02

(52) U.S. Cl. CPC B01J 19/02
USPC 585/372

(57) ABSTRACT

The present invention relates to a process for performing a hydrocarbon conversion or processing an output from a hydrocarbon conversion in the presence of an acidic ionic liquid. The hydrocarbon conversion, which is preferably an isomerization, is performed in apparatuses whose surfaces which come into contact with the acidic ionic liquid have been manufactured completely or at least partially from at least one nonmetallic material. The nonmetallic material in turn has been applied to at least one further material other than the nonmetallic material.

This patent application claims the benefit of pending U.S. provisional patent application Ser. No. 61/670,133 filed on Jul. 11, 2012, incorporated in its entirety herein by reference.

The present invention relates to a process for performing a hydrocarbon conversion or processing an output from a hydrocarbon conversion in the presence of an acidic ionic liquid. The hydrocarbon conversion itself, which is preferably an isomerization, and/or subsequent process steps which serve for processing of an output from the hydrocarbon conversion, are performed in apparatuses whose surfaces which come into contact with the acidic ionic liquid have been manufactured completely or at least partially from at least one nonmetallic material. The nonmetallic material in turn has been applied to at least one further material other than the nonmetallic material.

Ionic liquids can be used in various hydrocarbon conversion processes; they are especially suitable as catalysts for the isomerization of hydrocarbons. A corresponding use of an ionic liquid is disclosed, for example, in WO 2011/069929, where a specific selection of ionic liquids is used in the presence of an olefin for isomerization of saturated hydrocarbons, more particularly for isomerization of methylcyclopentane (MCP) to cyclohexane. A similar process is described in WO 2011/069957, but the isomerization therein is not effected in the presence of an olefin, but with a copper(II) compound.

US-A 2011/0155632 discloses a process for preparing products with a low hydrogen halide content, wherein the content of hydrogen halides is reduced in at least two separation stages, by stripping or distillation from a mixture which originates from a reactor and comprises an ionic liquid as a catalyst. In one embodiment of the process described in US-A 2011/0155632, the ionic liquid used as a catalyst is recycled into an alkylation reactor from a downstream phase separator, and hydrogen chloride is recycled from a first distillation column downstream of the phase separator and an isobutane-comprising stream from a second distillation column further downstream into the alkylation reactor. The apparatuses used for performance of, more particularly for processing, the process according to US-A 2011/0155632 are manufactured from one or more metals such as aluminum, iron or steel, which possess poor corrosion resistance with respect to hydrogen chloride. A similar disclosure to that in US-A 2011/0155632 is present in US-A 2011/0155640, but the process described therein relates to a hydrocarbon conversion.

WO 2010/075038 discloses a process for reducing the content of organic halides in a reaction product, these being formed as a result of a hydrocarbon conversion process in the presence of a halogen-comprising catalyst based on an acidic ionic liquid. The hydrocarbon conversion process is especially an alkylation; this process can optionally also be performed as an isomerization. The organic halides are removed from the reaction product by washing with an aqueous alkaline solution. WO 2010/075038, however, does not give any specific information as to the materials from which the surfaces of the apparatuses which are used in the workup process therein are manufactured.

It is an object of the present invention to provide a novel process for performing a hydrocarbon conversion or processing an output from a hydrocarbon conversion in the presence of an acidic ionic liquid.

The object is achieved by a process for performing a hydrocarbon conversion or processing an output from a hydrocarbon conversion in the presence of an acidic ionic liquid using at least one apparatus (V1), wherein the surfaces of the apparatus (V1) which come into contact with the acidic ionic liquid have been manufactured completely or at least partially from at least one nonmetallic material (W1), the nonmetallic material (W1) having been applied to at least one material (W2) other than the nonmetallic material (W1).

By means of the process according to the invention, it is advantageously possible to perform a hydrocarbon conversion in the presence of acidic ionic liquids and/or to process the output from such a hydrocarbon conversion. Due to the use of nonmetallic materials for manufacture of the surfaces which come into contact with the acidic ionic liquid in the corresponding apparatuses, the corrosion caused by the acidic ionic liquid can be distinctly reduced or even entirely suppressed. In this way, cost savings are possible, since the distinct increase in corrosion resistance allows the corresponding apparatuses to be operated for longer before a repair or even a complete exchange of the corresponding apparatuses has to be performed. In addition, impairments of the process caused by corrosion products can be reduced or entirely avoided.

Since, in accordance with the invention, there is no need to manufacture the complete apparatus (V1) from nonmetallic materials, but only (completely or at least partially) the surfaces which come into contact with the acidic ionic liquid, it is possible to dispense with additional costs by resorting to cheaper and/or more mechanically stable materials for the corresponding parts of apparatus (V1) where the acidic ionic liquid cannot cause any corrosion.

The aforementioned advantages become particularly apparent in the process according to the invention when the nonmetallic material (W1) used is an oxidic material, preferably glass, or a polymer, preferably a fluorinated polymer, and the material (W2) used is steel. If the nonmetallic material (W1) is glass, the nonmetallic material (W1) and the material (W2) especially preferably form an enamel.

A further advantage of the process according to the invention is considered to be that it is not absolutely necessary that the surfaces of the apparatus (V1) which come into contact with the acidic ionic liquid be manufactured completely from the nonmetallic material (W1). For instance, partial regions of these surfaces may also be manufactured from a material (W2) other than the nonmetallic material (W1), and/or from a metallic material (W3) comprising tantalum. The metallic material (W3) comprising tantalum is used especially when a corresponding apparatus (V1) has been used over a prolonged period and, for example, cracks have formed in the surfaces manufactured from the nonmetallic material (W1). The metallic material (W3) comprising tantalum can be used in a simple and inexpensive manner for repair/restoration of such defects in the surfaces manufactured from the nonmetallic material (W1). It will be appreciated that it is conceivable, even prior to startup of a corresponding apparatus (V1), that partial regions of the surfaces which come into contact with the acidic ionic liquid are manufactured solely from the metallic material (W3) comprising tantalum and/or that this material (W3) has been applied to corresponding partial regions/sites which have been manufactured from the nonmetallic material (W1).

The process according to the invention for performance of a hydrocarbon conversion or processing of an output from a hydrocarbon conversion which is performed in the presence of an acidic ionic liquid in apparatuses having surfaces made from nonmetallic materials is defined in detail hereinafter.

In the context of the present invention, either a hydrocarbon conversion may be performed, or an output from a hydrocarbon conversion is processed. Preferably, in the context of the present invention, both a hydrocarbon conversion and a corresponding processing operation on an output from the corresponding hydrocarbon conversion are performed.

Hydrocarbon conversions as such are known to those skilled in the art. For example, the hydrocarbon in question can be used to perform a chemical conversion or chemical reaction, i.e. the hydrocarbon can be chemically converted, modified or altered in terms of its composition or structure in some other way. The hydrocarbon conversion is preferably selected from an alkylation, a polymerization, a dimerization, an oligomerization, an acylation, a metathesis, a polymerization or copolymerization, an isomerization, a carbonylation or combinations thereof. Alkylations, isomerizations, polymerizations etc. are known to those skilled in the art. Especially preferably in the context of the present invention, the hydrocarbon conversion is an isomerization.

Processing of an output from a hydrocarbon conversion is understood in the context of the present invention to mean that the product obtained in a hydrocarbon conversion, preferably the isomerization product, is removed as an output completely or partially, preferably completely, from the corresponding apparatus for performance of the hydrocarbon conversion. This output is subsequently subjected to one or more processing steps. Processing steps as such are known to those skilled in the art, for example purification steps such as phase separations and/or distillations by which the output from the hydrocarbon conversion is freed, for example, from reactants, solvents, by-products and/or catalysts. Preferably, in the context of the present invention, as a result of the processing of the output from the hydrocarbon conversion, a removal of the acidic ionic liquid from the hydrocarbons, i.e. from the product of the hydrocarbon conversion, is performed.

In the context of the present invention, the hydrocarbon conversion is effected in the presence of an acidic ionic liquid having the composition K1AlₙX₍₃ₙ₊₁₎ where K1 is a monovalent cation, X is halogen and 1<n<2.5. Such acidic ionic liquids are known to those skilled in the art; they are disclosed (alongside further ionic liquids), for example, in WO 2011/069929. For example, mixtures of two or more acidic ionic liquids may be used, preference being given to using one acidic ionic liquid.

K1 is preferably an unsubstituted or at least partly alkylated ammonium ion or a heterocyclic (monovalent) cation, especially a pyridinium ion, an imidazolium ion, a pyridazinium ion, a pyrazolium ion, an imidazolinium ion, a thiazolium ion, a triazolium ion, a pyrrolidinium ion, an imidazolidinium ion or a phosphonium ion. X is preferably chlorine or bromine.

The acidic ionic liquid more preferably comprises, as a cation, an at least partly alkylated ammonium ion or a heterocyclic cation and/or, as an anion, a chloroaluminate ion having the composition AlₙCl₍₃ₙ₊₁₎ where 1<n<2.5. The at least partly alkylated ammonium ion preferably comprises one, two or three alkyl radicals (each) having 1 to 10 carbon atoms. If two or three alkyl substituents are present with the corresponding ammonium ions, the respective chain length can be selected independently; preferably, all alkyl substituents have the same chain length. Particular preference is given to trialkylated ammonium ions having a chain length of 1 to 3 carbon atoms. The heterocyclic cation is preferably an imidazolium ion or a pyridinium ion.

The acidic ionic liquid especially preferably comprises, as a cation, an at least partly alkylated ammonium ion and, as an anion, a chloroaluminate ion having the composition AlₙCl₍₃ₙ₊₁₎ where 1<n<2.5. Examples of such particularly preferred acidic ionic liquids are trimethylammonium chloroaluminate and triethylammonium chloroaluminate.

The acidic ionic liquid used in the context of the present invention is preferably used as a catalyst in the hydrocarbon conversion, especially as an isomerization catalyst.

In principle, it is possible in the context of the present invention to use any hydrocarbons, provided that at least one of the hydrocarbons used can be subjected in the presence of the above-described acidic ionic liquids to a hydrocarbon conversion, especially to an isomerization. On the basis of his or her specialist knowledge, the person skilled in the art knows which hydrocarbons can be subjected by means of acidic ionic liquids to a hydrocarbon conversion, and more particularly which hydrocarbons are isomerizable. For example, it is possible to use mixtures of two or more hydrocarbons, but it is also possible to use only one hydrocarbon. Thus, it is possible in the context of the present invention that, in a mixture comprising two or more hydrocarbons, only one of these hydrocarbons is subjected to a hydrocarbon conversion, especially isomerized. Optionally, such mixtures may also comprise compounds which are not themselves hydrocarbons but are miscible therewith.

The hydrocarbon used in the hydrocarbon conversion is preferably methylcyclopentane (MCP) or a mixture of methylcyclopentane (MCP) with at least one further hydrocarbon selected from cyclohexane, n-hexane, isohexanes, n-heptane, isoheptanes, methylcyclohexane or dimethylcyclopentanes.

More preferably, a mixture of methylcyclopentane, (MCP) with at least one further hydrocarbon selected from cyclohexane, n-hexane, isohexanes, n-heptane, isoheptanes, methylcyclohexane or dimethylcyclopentanes is used, the proportion of branched hydrocarbons in the mixture being greater than 50% by weight (based on the sum of all hydrocarbons).

According to the invention, the process is performed in such away that, in the course of performance of a hydrocarbon conversion or processing of output from the hydrocarbon conversion, at least one apparatus (V1) is used. The apparatus (V1) is configured such that the surfaces of the apparatus (V1) which come into contact with the acidic ionic liquid have been manufactured completely or at least partially from at least one nonmetallic material (W1). The nonmetallic material (W1) in turn has been applied to at least one material (W2) other than the nonmetallic material (W1).

The corresponding apparatuses (V1) as such are known to those skilled in the art according to the respective and use. For example, the apparatus may be a reactor, a (stirred) tank, a conduit and/or a distillation apparatus. The specific configuration of the corresponding apparatus in the context of the process according to the invention is selected by the person skilled in the art on the basis of his or her specialist knowledge according to the respective end use. If, for example, an isomerization is to be performed, the person skilled in the art selects, as the apparatus (V1) for this purpose, preferably a stirred tank or a stirred tank cascade. A “stirred tank cascade” means that two or more, for example three or four, stirred tanks are connected in succession (in series). In other words, this means that the stirred tank constitutes an apparatus (V1) which is used in the context of the process according to the invention for performance of a hydrocarbon conversion, especially of an isomerization. For processing of the output from a hydrocarbon conversion, especially an isomerization, in accordance with the invention, the apparatus (V1) used, in contrast, is not such a stirred tank; instead, for example (as explained in detail below), a phase separator and/or a flash apparatus is used for this purpose.

Irrespective of the specific end use, it is, however, a prerequisite for any apparatus (V1) that (as already explained above) the surfaces of the apparatus (V1) which come into contact with the acidic ionic liquid have been manufactured completely or at least partially from at least one nonmetallic material (W1), the nonmetallic material (W1) having been applied to at least one material (W2) other than the nonmetallic material (W1). Those surfaces of parts of the apparatus (V1) which do not come into contact with the acidic ionic liquid, for example an outer housing wall or a securing device, may, in contrast, be manufactured from any desired materials. It is equally possible that such surfaces or parts of the apparatus (V1) have likewise been manufactured from a nonmetallic material (W1) and/or a material (W2).

According to the invention, it is not absolutely necessary that, within such an apparatus (V1), every surface which, in the course of the corresponding process step, comes into contact with the acidic ionic liquid has been manufactured from at least one nonmetallic material (W1). For instance, it is conceivable that, within such an apparatus (V1), at least 50% of the surfaces in question which come into contact with the acidic ionic liquid have been manufactured from the nonmetallic material (W1). The surfaces of apparatus (V1) which come into contact with the acidic ionic liquid have preferably been manufactured to an extent of at least 80%, more preferably to an extent of at least 95%, especially to an extent of 100%, from the nonmetallic material (W1). The above percentages are based on the total (internal) surface area of the apparatus (V1) in question in each case which comes into contact with the acidic ionic liquid.

If the surfaces of the apparatus (V1) which come into contact with the acidic ionic liquid have not been manufactured completely from the nonmetallic material (W1), partial regions of these surfaces may also be manufactured from a material (W2) other than the nonmetallic material (W1), and/or from a metallic material (W3) comprising tantalum. Preferably not more than 20%, especially not more than 5%, of the surfaces of the apparatus (V1) which come into contact with the acidic ionic liquid have been manufactured from a material (W2) other than the nonmetallic material (W1), and/or from a metallic material (W3) comprising tantalum.

The surfaces of apparatus (V1) which come into contact with the acidic ionic liquid, at the sites where they have not been manufactured from the nonmetallic material (W1) have preferably been manufactured from a metallic material (W3) comprising tantalum. More particularly, the ratio of the partial regions (surface areas) of nonmetallic material (W1) to metallic material (W3) comprising tantalum is greater than 95:5. The nonmetallic material (W1), the material (W2) and the metallic material (W3) comprising tantalum are defined in detail in the text below.

In the context of the process according to the invention, it is preferred that two or more, for example three, four or five, such apparatuses (V1) are used, and these may be different in terms of their end use and/or features. For example, the first apparatus (V1) in question is a stirred tank, the second apparatus (V1) in question a phase separator, and the third apparatus (V1) in question a flash apparatus, these being connected to one another by at least one conduit, and these conduits may likewise he apparatuses (V1) in the context of the present invention. For instance, it is also conceivable that, in the above example, the first apparatus (V1) in question is based on another nonmetallic material (W1) compared to the second apparatus (V1) in question and/or the conduits which connect the respective apparatuses to one another.

The apparatus (V1) is preferably a reactor, a stirred tank, a conduit, a phase separation unit or a separation apparatus. Additionally preferably, the phase separation unit is a phase separator or the separation apparatus is a vaporizer, a rectifying column, a flash apparatus or a stripping apparatus, preferably a flash apparatus.

In the context of the present invention, the term “flashing”, which is performed in a corresponding flash apparatus (V1) and can also be referred to as flash vaporization, is understood to mean the following: flash vaporization (flashing) involves decompressing a liquid mixture, without external heat supply or removal, into an apparatus suitable for flashing (flash apparatus V1), for example into a vapor/liquid separator or into a rectifying column. The liquid mixture may originate, for example, from a reaction stage operated at higher pressure. However, it can also be preheated in a preheater, in which case the pressure in the preheater must be higher than the pressure in the downstream separator. The vapor forming in the course of decompression has a higher proportion of relatively low-boiling components than the mixture entering the separator. Flash vaporization thus ensures partial separation of the incoming mixture.

In a preferred embodiment of the present invention, the hydrocarbon conversion is performed in a reactor or stirred tank, the reactor or stirred tank being connected via a conduit to a phase separation unit and the phase separation unit being connected in turn via a conduit to a separation apparatus. The individual (aforementioned) apparatuses or conduits are preferably each configured as an apparatus (V1) in which the surfaces which come into contact with the acidic ionic liquid have been manufactured completely from at least one nonmetallic material (W1) which has been applied to at least one material (W2) other than the nonmetallic material (W1). Additionally preferably, the phase separation unit is connected via a recycle line for the acidic ionic liquid to the reactor or stirred tank in which the hydrocarbon conversion is performed.

The nonmetallic materials (W1) used may in principle be any nonmetallic materials known to those skilled in the art for the corresponding end use (for example isomerization or distillation). For example, it is possible to use only a single nonmetallic material (W1), but it is optionally also possible to use combinations of two or more different nonmetallic materials (W1), preference being given to using one nonmetallic material (W1) per apparatus (V1). A combination of two (or more) different nonmetallic materials (W1) means that, within the same apparatus (V1), partial regions of the corresponding surfaces have been manufactured from a first nonmetallic material (W1), but other partial regions from another nonmetallic material (W1) (other than the first).

The expression “surfaces of the apparatus (V1) which come into contact with the acidic ionic liquid have been manufactured completely or at least partly from at least one nonmetallic material (W1)” is also understood to mean in the context of the present invention that the material used for manufacture of the corresponding surfaces comprises at least 80%, more preferably at least 90%, especially 100%, of at least one nonmetallic material (W1). This means that it is optionally also possible to manufacture the corresponding surfaces using mixtures of at least one nonmetallic material (W1) and at least one further compound (material) not covered by the definition of a nonmetallic material (W1).

The nonmetallic material (W1) is preferably an oxidic material or a polymer. The oxidic materials used may be any oxides which are known to those skilled in the art and are based on compounds of nonmetals, especially silicon, and optionally also boron, with oxygen, provided that the material is suitable on the basis of its chemical and mechanical properties for the manufacture of surfaces. In the context of the present invention, silicon is considered to be a nonmetal. The oxidic material is especially preferably glass. If the nonmetallic material (W1) used is a polymer, this is preferably a fluorinated polymer, especially polytetrafluoroethylene (PTFE) or a perfluoroalkoxy polymer (PFA). PFA is a copolymer of tetrafluoroethylene (TFE) and perfluoroalkoxyvinyl ethers, for example perfluorovinyl propyl ether.

The materials (W2) used may in principle be any materials known to those skilled in the art for the corresponding end use (for example isomerization or distillation). The material (W2) may he a metallic or a nonmetallic material. If the material (W2) is a nonmetallic material, this is different than the nonmetallic material (W1) in terms of its chemical composition. The material (W2) is preferably a metallic material, for example in the form of metal alloys, and the material (W2) is more preferably steel, especially stainless steel.

In the context of the present invention, it is preferable that the nonmetallic material (W1) has been applied in the form of a sheet or layer on the material (W2) which functions as a substrate or underlayer. If the nonmetallic material (W1) is a glass, the nonmetallic material (W1) and the material (W2) preferably (together) form an enamel. The enamel is especially preferably formed from glass as the nonmetallic material (W1) and steel as the material (W2). Such an enamel is also referred to as steel enamel.

In one embodiment of the present invention, the nonmetallic material (W1) is a polymer with which apparatus (V1) has been coated or lined. It is additionally preferable that the nonmetallic material (W1) is a polymer with which apparatus (V1) is lined and materials (W1) and (W2) are bonded to one another. The materials (W1) and (W2) are preferably bonded by a synthetic resin-based adhesive.

The metallic material (W3) comprising tantalum is included in the definition of material (W2), provided that it is a metal. The metallic material (W3) preferably comprises at least 95% by weight of tantalum (Ta); the remaining proportions are preferably likewise metals, especially tungsten (W), niobium (Nb), hafnium (Hf) and/or silver (Ag). The metallic material (W3) comprising tantalum is preferably used to repair cracks which have formed in the surfaces manufactured from the nonmetallic material (W1). Such cracks or other defects can occur, for example, when a corresponding apparatus (V1) has been used over a prolonged period. In other words, this means that the metallic material (W3) is applied completely or partially as a sheet or layer of the nonmetallic material (W1) or completely or partially replaces the latter, the nonmetallic material (W1) in turn having been applied to the material (W2) which functions as a substrate or underlayer, provided that the metallic material (W3) replaces the nonmetallic material (W1).

In the hydrocarbon conversion which can be performed in the context of the present invention, as well as the acidic ionic liquid, at least one hydrogen halide (HX) is preferably also present. The presence of a hydrogen halide in addition to the acidic ionic liquid, however, is not obligatory in the context of the process according to the invention. The hydrogen halides (HX) used may in principle be any conceivable hydrogen halides, for example hydrogen fluoride (HF), hydrogen chloride (HCl), hydrogen bromide (HBr) or hydrogen iodide (HI), The hydrogen halides can optionally also be used as a mixture, but preference is given in the context of the present invention to using only one hydrogen halide. Preference is given to using the hydrogen halide whose halide moiety is also present in the above-described acidic ionic liquid (at least partly) in the corresponding anion. The hydrogen halide (HX) is preferably hydrogen chloride (HCl) or hydrogen bromide (HBr). The hydrogen halide (HX) is more preferably hydrogen chloride (HCl). The hydrogen halide (HX) is preferably used as a cocatalyst.

As already explained above, due to the hydrocarbon conversion in the presence of an acidic ionic liquid and optionally of a hydrogen halide (HX), the chemical structure of at least one of the hydrocarbons used is altered. The hydrocarbons obtained in the hydrocarbon conversion (“product of the hydrocarbon conversion” or “hydrocarbon product”) thus differ in terms of (chemical) composition and/or amount of the hydrocarbons present therein from the corresponding hydrocarbon composition present prior to the hydrocarbon conversion, especially prior to the isomerization. Since the hydrocarbon conversion to be performed in such hydrocarbon conversions, especially in isomerization processes, frequently does not proceed to an extent of 100% (i.e. to completion), the product generally still also comprises the hydrocarbon with which the hydrocarbon conversion has been performed (in smaller amounts than prior to the hydrocarbon conversion). If, for example, MCP is to be isomerized to cyclohexane, the isomerization product frequently comprises a mixture of cyclohexane and (in a smaller amount than before the hydrocarbon conversion) MCP. The above-described hydrocarbon product is used in the context of the present invention to perform the processing of the hydrocarbon conversion.

The hydrocarbon present in the product of the hydrocarbon conversion is preferably cyclohexane or a mixture comprising cyclohexane. The hydrocarbon present in the product of the hydrocarbon conversion is more preferably cyclohexane or a mixture of cyclohexane with at least one further hydrocarbon selected from methylcyclopentane (MCP), n-hexane, isohexanes, n-heptane, isoheptanes, methylcyclohexane and dimethylcyclopentanes.

The hydrocarbon present in the product of the hydrocarbon conversion is especially preferably a mixture of cyclohexane, MCP and at least one further hydrocarbon. The further hydrocarbon is preferably selected from n-hexane, isohexanes, n-heptane, isoheptanes, methylcyclohexane and dimethylcyclopentanes. If the hydrocarbon conversion is performed as an isomerization, the proportion of branched hydrocarbons in the product of the hydrocarbon conversion is preferably less than 5% by weight (based on the sum of all hydrocarbons). Particular preference is given in the context of the present invention to isomerizing methylcyclopentane (MCP) to cyclohexane. It is additionally preferred that, after the hydrocarbon conversion, cyclohexane is isolated in the course of processing. The cyclohexane is isolated by methods known to those skilled in the art from the output from the hydrocarbon conversion.

In a preferred embodiment of the present invention, the product of the hydrocarbon conversion comprises i) as a hydrocarbon a mixture of cyclohexane with at least one further hydrocarbon selected from methylcyclopentane (MCP), n-hexane, isohexanes, n-heptane, isoheptanes, methylcyclohexane and dimethylcyclopentanes, ii) hydrogen chloride (HCl) and iii) an acidic ionic liquid which has, as a cation, an at least partly alkylated ammonium ion and, as an anion, a chloroaluminate ion having the composition AlₙCl₍₃ₙ₊₁₎ where 1<n<2.5.

If the hydrocarbon conversion in the context of the present invention is an isomerization, the isomerization is preferably performed as follows. The performance of an isomerization of hydrocarbons in the presence of an ionic liquid as a catalyst and optionally a hydrogen halide as a cocatalyst is known to those skilled in the art. The hydrocarbons and the ionic liquid in the isomerization preferably each form a separate phase, though portions of the ionic liquid may be present in the hydrocarbon phase and portions of the hydrocarbons in the ionic liquid phase. The hydrogen halide, especially hydrogen chloride, is introduced, preferably in gaseous form, into the apparatus (V1) for performance of the isomerization. The hydrogen halide may be present, at least in portions, in the two aforementioned liquid phases; the hydrogen halide preferably forms a separate, gaseous phase in addition.

The isomerization is preferably performed at a temperature between 0° C. and 100° C., especially preferably at a temperature between 30° C. and 60° C. It is additionally preferred that the pressure in the isomerization is between 1 and 20 bar abs. (absolute), preferably between 2 and 10 bar abs.

The isomerization is preferably performed in the apparatus (V1) in such a way that two liquid phases and one gaseous phase are present in a stirred tank or a stirred tank cascade. The first liquid phase comprises the acidic ionic liquid to an extent of at least 90% by weight and the second liquid phase comprises the hydrocarbons to an extent of at least 90% by weight. The gas phase comprises at least one hydrogen halide, preferably hydrogen chloride, to an extent of at least 90% by weight. Optionally, a solid phase may also be present, this comprising components from which the ionic liquid is formed in solid form, for example AlCl₃. The pressure and composition of the gas phase are set here such that the partial pressure of the gaseous hydrogen halide, especially of HCl gas, in the gas phase is between 1 and 20 bar abs., preferably between 2 and 10 bar abs.

The present invention is to be illustrated hereinafter by examples.

The chemical stability of various materials with respect to a mixture consisting of the ionic liquid trimethylammonium heptachlorodialuminate and cyclohexane in a volume ratio of 5 is tested, in order to verify the use thereof in a process for performing a hydrocarbon conversion in the presence of an acidic ionic. One of these tests involves an oxidic material and tantalum as an optional material, and one involves a polymer, as possible coating materials for stainless steel.

### EXAMPLE 1

### Corrosion Test of Commercially Available E 9115 Enamel (Vitreous, Oxidic Material and Tantalum in an Acidic Ionic Liquid ((CH₃)₃NH AlₙCl₃ₙ₊₁ Where n=1)

The corrosion characteristics of specimens consisting of ahoy-free steel coated with an enamel layer of thickness 50 μm, and pure tantalum, are examined in an anhydrous mixture of trimethylammonium heptachlorodialuminate in a 4×7-day prolonged immersion test at 100° C. In the course of this, the mixture is constantly stirred, inertized with nitrogen and changed weekly. Two corrosion samples of each material are examined in the liquid, in the liquid/vaporous phase boundary and in the vapor space.

With careful exclusion of moisture, the medium is introduced into the test vessel under nitrogen atmosphere, said vessel having been purged with dried nitrogen (CaCl₂ drying tower) for 30 minutes beforehand.

The following results were obtained:

TABLE 1
Corrosion stability analysis of tantalum and enamel in
TMA-Al₂Cl₇ at 100° C.

| | Mean linear corrosion rate v₁ [mm/year] | | |
|---|---|---|---|
| Material | Liquid | Phase boundary | Vapor space |
| Tantalum | 0.0021 | 0.0019 | 0.0011 |
| on stainless | | | |
| steel | | | |
| E 9115 | 0.0037 | 0.0056 | 0.0028 |
| enamel on | | | |
| stainless | | | |
| steel | | | |

The technical limits determined with regard to corrosion resistance extend to 0.05 mm/year for the enamel coating without roughening and v1=0.02 mm/year for the tantalum without local corrosion, and this shows that enameled steel in anhydrous trimethylammonium heptachloroaluminate is corrosion-resistant at 100″C. Tantalum is likewise corrosion-resistant under said conditions and can thus serve for refinishing studies in the contemplated apparatuses.

### EXAMPLE 2

### Determination of the Chemical Durability of FEP (Tetrafluoroethylene-hexafluoropropylene) with Respect to a Mixture of Trimethylammonium Heptachlorodialuminate and Cyclohexane

The chemical durability of the polymer materials with respect to TMA-AL2Cl7 is determined at 50° C.

The following polymer is tested:

Symalit FEP (tetrafluoroethylene-hexafluoropropylene)

Corresponding tensile specimens (DIN EN ISO 527-2, 1BA type) were machined out of sheet material. The test specimens thus manufactured were stored in the liquid phase of the TMA-AL₂Cl₇/cyclohexane medium. Storage was effected at 50° C. in a glass vessel with reflux cooling and N₂ blanketing. The medium was not changed during the test. After 28, 56 and 112 days of storage time, the change in dimensions, mass and hardness of the specimens is determined, and tensile tests (ISO 527) are conducted to determine the strength characteristics after 56 and 112 days. The evaluation to determine the chemical durability is effected based on ISO 4433-2 or 4433-4. The results are compiled in the tables which follow.

TABLE 2
Determination of the chemical durability of FEP with respect to TMA-Al₂Cl₇ at
50° C.

| | | | | | | Percentage | |
|---|---|---|---|---|---|---|---|
| Storage | | [Days] | | | | change | |
| time | | 0 | 28 | 56 | 112 | (0-112) | Evaluation |
| Mass | [g] | 3.1709 | 3.1731 | 3.1691 | 3.1771 | 0.20% | stable |
| Modulus of | [MPa] | 633 | | 560 | 517 | −18.30% | stable |
| elasticity | | | | | | | |
| Breaking | [MPa] | 27.1 | | 27.2 | 24.1 | −11.10% | stable |
| strength | | | | | | | |
| Elongation | [%] | 324 | | 319 | 324 | 0.00% | stable |
| at break | | | | | | | |

Table 3: Determination of the chemical durability of E-CTFE with respect to TMA-Al₂Cl₇ at 50° C.

The thermoplastic FEP examined is classified as chemically durable with respect to the medium TMA-AL₂Cl₇ at 50° C. based on ISO 4433-2.

1.-19. (canceled)

20. A process for performing a hydrocarbon conversion or processing an output from a hydrocarbon conversion in the presence of an acidic ionic liquid using at least one apparatus (V1), wherein the surfaces of the apparatus (V1) which come into contact with the acidic ionic liquid have been manufactured completely or at least partially from at least one nonmetallic material (W1), the nonmetallic material (W1) having been applied to at least one material (W2) other than the nonmetallic material (W1).

21. The process according to claim 20, wherein the nonmetallic material (W1) is an oxidic material or a polymer or the material (W2) is steel.

22. The process according to claim 211, wherein the oxidic material is glass or the polymer is a fluorinated polymer.

23. The process according to claim 22, wherein the fluorinated polymer is polytetrafluoroethylene (PTFE) or a perfluoroalkoxy polymer (PFA).

24. The process according to claim 20, wherein the nonmetallic material (W1) is glass and forms an enamel with material (W2).

25. The process according to claim 20, wherein the nonmetallic material (W1) is a polymer with which apparatus (V1) has been coated or lined.

26. The process according to claim 25, wherein the nonmetallic material (W1) is a polymer with which apparatus (V1) is lined and materials (W1) and (W2) are bonded to one another.

27. The process according to claim 26, wherein materials (W1) and (W2) are bonded to one another by a synthetic resin-based adhesive.

28. The process according to claim 20, wherein apparatus (V1) is a reactor, stirred tank, conduit, phase separation unit or separation apparatus.

29. The process according to claim 28, wherein the phase separation unit is a phase separator or the separation apparatus is a vaporizer, a rectifying column, a flash apparatus or a stripping apparatus.

30. The process according to claim 29, wherein the separation apparatus is a flash apparatus.

31. The process according to claim 20, wherein the surfaces of apparatus (V1) which come into contact with the acidic ionic liquid have been manufactured to an extent of at least 80% from the nonmetallic material (W1).

32. The process according to claim 31, wherein the extent is 100%.

33. The process according to claim 20, wherein the surfaces of apparatus (V1) which come into contact with the acidic ionic liquid, at the sites where they have not been manufactured from the nonmetallic material (W1), have been manufactured from a metallic material (W3) comprising tantalum.

34. The process according to claim 20, wherein the hydrocarbon conversion is performed in a reactor or stirred tank, the reactor or stirred tank being connected via a conduit to a phase separation unit and the phase separation unit being connected in turn via a conduit to a separation apparatus.

35. The process according to claim 34, wherein the individual apparatuses or conduits are each configured as an apparatus (V1) in which the surfaces which come into contact with the acidic ionic liquid have been manufactured completely from at least one nonmetallic material (W1) which has been applied to at least one material (W2) other than the nonmetallic material (W1).

36. The process according to claim 34, wherein the phase separation unit is connected via a recycle line for the acidic ionic liquid to the reactor or stirred tank in which the hydrocarbon conversion is performed.

37. The process according to claim 20, wherein the hydrocarbon conversion is performed in the presence of at least one hydrogen halide (HX).

38. The process according to claim 20, wherein the acidic ionic liquid has the composition K1AlₙX₍₃ₙ₊₁₎ where K1 is a monovalent cation, X is halogen and 1<n<2.5.

39. The process according to claim 38, wherein the cation present in the acidic ionic liquid being an at least partly alkylated ammonium ion or a heterocyclic cation or the anion present being a chloroaluminate ion having the composition AlₙCl₍₃ₙ₊₁₎ where 1<n<2.5.

40. The process according to claim 20, wherein the hydrocarbon conversion is selected from an alkylation, a polymerization, a dimerization, an oligomerization, an acylation, a metathesis, a polymerization or copolymerization, an isomerization, a carbonylation or combinations thereof.

41. The process according to claim 40, wherein the hydrocarbon conversion is an isomerization of methylcyclopentane (MCP) to cyclohexane.

42. The process according to claim 20, wherein the hydrocarbon conversion is performed with a hydrocarbon mixture comprising methylcyclopentane (MCP) or a mixture of MCP and at least one further hydrocarbon selected from n-hexane, isohexanes, n-heptane, isoheptanes, methylcyclohexane and dimethylcyclopentanes.

43. The process according to claim 20, wherein the hydrocarbon conversion is followed, in the course of processing, by isolation of cyclohexane.

44. The process according to claim 37, wherein the at least one hydrogen halide (HX) is hydrogen chloride (HCl).
